(19) United States
(12) Patent Application Publication
(10) Pub. No.: US 2020/0409538 A1
(43) Pub. Date: Dec. 31, 2020

(54) HANDS-FREE SYSTEM INTERFACE BASED ON EYE AND OBJECT MOTION

(71) Applicants: Elias Lundgaard Pedersen, Copenhagen (DK); Frederik Ostergaard Neble, Copenhagen (DK)

(72) Inventors: Elias Lundgaard Pedersen, Copenhagen (DK); Frederik Ostergaard Neble, Copenhagen (DK)

(21) Appl. No.: 16/882,951

(22) Filed: May 26, 2020

Related U.S. Application Data
(60) Provisional application No. 62/867,013, filed on Jun. 26, 2019.

(51) Int. Cl. G06F 3/0484; G06F 3/01

(52) U.S. Cl. CPC G06F 3/04845; G06F 3/013

(57) ABSTRACT

The invention herein disclosed and claimed is a hands-free system interface that utilizes eye pupil motion correlated with display-screen object motion to determine an attended object and to interact based on whether the attended object represents a control selection or a data element selection.

### TECHNICAL FIELD

The invention is a hands-free interface allowing control of a system and data selection.

### BACKGROUND OF THE INVENTION

With the change from command-line to graphical-user interfaces (GUIs) in the 1980s, users had a more intuitive way of navigating a display screen and selecting objects using devices such as a “mouse” or touch pad. However, in both cases, users had to have access to either the mouse device or touch pad (or touch screen) in order to interact with the system. Later innovations made use of voice recognition/voice synthesis to enable hands-free interface with a system. Here, though, the user had to be vocal. Recent advances in user control of systems with eye tracking has enabled users who were unable to vocalize to control systems using eye gaze. However, such systems typically required specialized cameras and programs to determine the geometries inherent in the interface scheme. What has been missing, however, is an interface that makes use of users' eyes but does not require specialized optical subsystems. Such an interface would markedly improve hands-free user control where users had special needs, and where users had no physical access to a touch screen or mouse.

### BRIEF DESCRIPTION OF INVENTION

The invention herein disclosed and claimed is a novel approach to hands-free system interface using eye motion detection and screen object motion correlation. By using built-in front-facing cameras, as are now found in many varieties of handheld, laptop and desktop system, and coordinating the motion of objects on a display screen with detected motion of eye pupils, it is possible with accuracy to determine the object a user is attending (e.g. looking at and following its motion). Using novel display/user interactions, a user has feedback allowing system control and object selection. With those capabilities, for example, a user can elect to write a message, select the alphabetic characters that make up the message, and convey the message to one or more recipients, all done using eye motion in the absence of vocalizing or touching the system.

Furthermore, additional nuances enable a user to control the motion of objects on the screen and to enrich controls by using the duration of object attention.

### BRIEF DESCRIPTION OF DRAWINGS

FIG. 1 depicts the system which includes a user looking at the screen as part of the closed loop scheme.

FIG. 2 depicts the display screen with a set of objects arranged in two concentric circular paths where the outer circle of objects rotates in one direction and the inner circle of objects rotates in the opposite direction.

FIG. 3 illustrates how eye motion and object motion can be correlated to enable the system to determine at which object a user is looking.

In FIGS. 4A, 4B and 4C, FIG. 4A depicts icon in an outer concentric path that is initially looked at (e.g. attended). FIG. 4B shows the icon becoming enlarged and moving out of the concentric path. And FIG. 4C shows that icon, in its new location, now showing a new set of icons.

In FIGS. 5A, 5B and 5C, a user attends a first icon (FIG. 5A) then attends another icon further along in the same direction of rotation (FIG. 5B) which then causes rotation speed to increase (FIG. 5C).

In FIGS. 6A, 6B and 6C, a user first attends a first icon (FIG. 6A), then attends an icon further back in the direction of rotation (FIG. 6B) which causes rotation speed to decrease (FIG. 6C).

In FIGS. 7A and 7B, a user looks at an icon that is close to a second icon on the same concentric path (FIG. 7A) wherein the system may automatically separate the two icons (FIG. 7B) so as to make a more determinative decision as to which of the two icons the user is attending.

### DETAILED DESCRIPTION OF INVENTION

The invention herein disclosed and claimed is a hands-free system interface that enables users to control a system and select display-screen objects using only eye motion correlated with display-screen object motion.

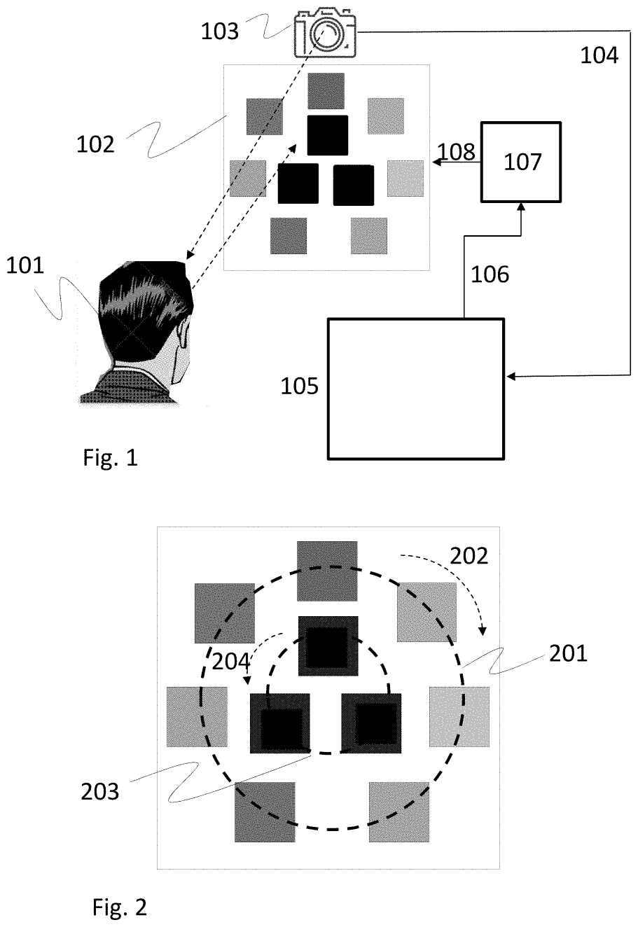

An embodiment of the interface system is illustrated in FIG. 1. A user (101) looks at a system's display screen (102) as a front-facing camera (103) conveys image data to a processing subsystem (105) via path 104. The processing subsystem (105) sends resulting processed data and display-control data over path 106 to a display driver subsystem (107) which in turn send display-control signals to the display (102) via path 108. The system may be implemented in a laptop, desktop, handheld, virtual-reality (VR) and augmented-reality (AR) devices. It may be implemented in other devices wherein users are allowed to control and select data without use of hands or voice input.

The display screen (102) of FIG. 1 shows geometrically-shaped icons. These may be circular, ovoid, triangular, rectangular, polygons with more than four sides, and so on. These may also be two-dimensional or three-dimensional. Where they are three-dimensional, they may be spheroid, cuboid, ovoid, and so on. These icons are organized, as shown in FIG. 2, on two geometrically shaped paths 201 and 203 wherein the objects in the larger circumferential path (201) travel in a first rotational direction (202). The objects on the smaller circumferential path (203) travel in a direction opposite to that of 202 (204). As the user looks at the screen, and begins to pay attention (e.g. attending) one of the objects, and following its motion around its geometric path, the camera in FIG. 1 (103) is providing image data related to the motion of the user's eye pupils. A circular path provides a regular sine wave motion function whereas other geometrical paths will produce other wave functions. The exemplary description in FIG. 2 shows concentric circular paths.

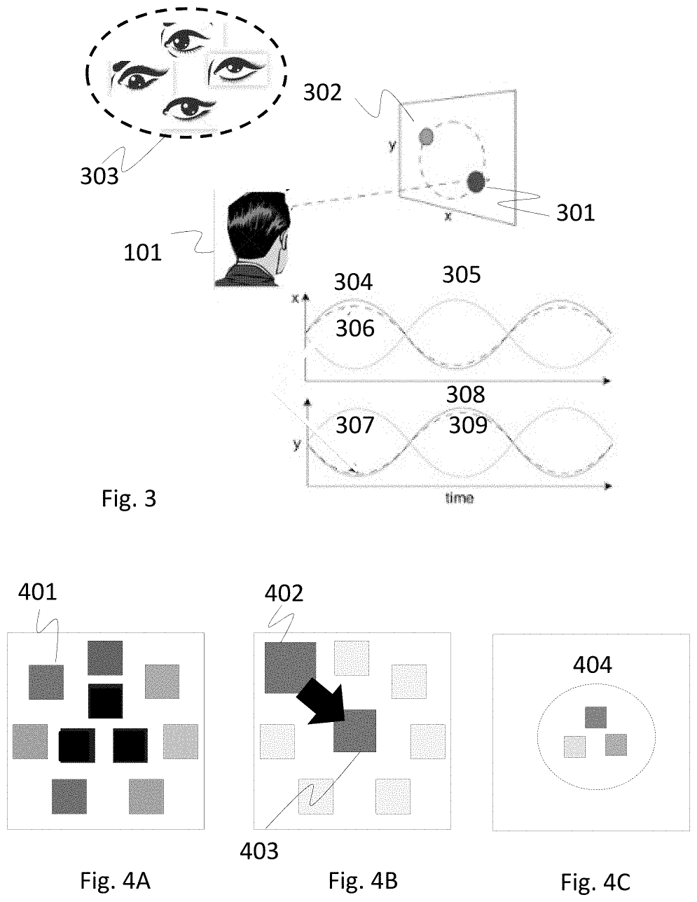

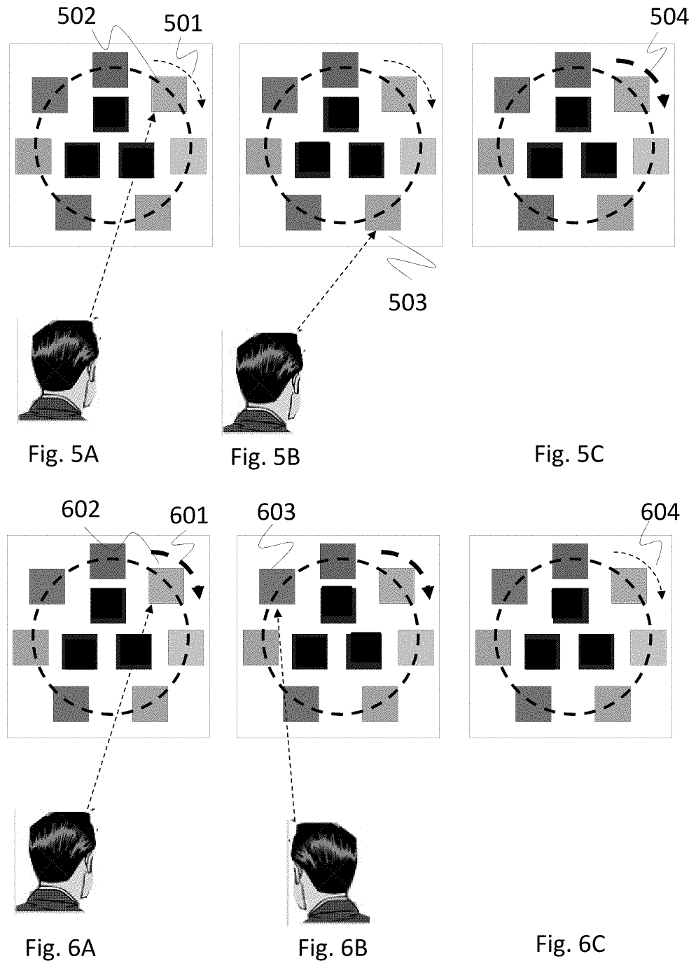

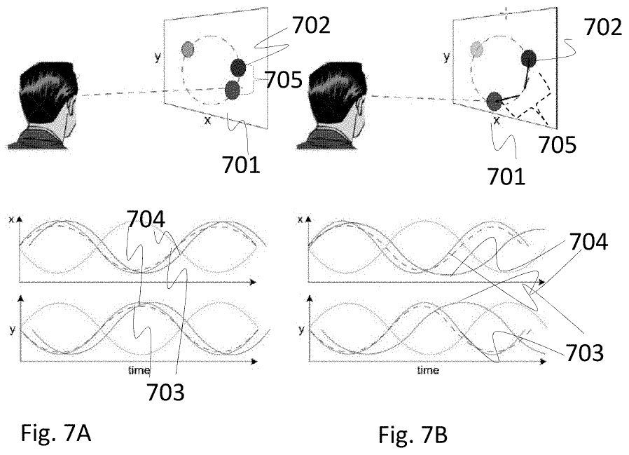

In FIG. 3, wherein the user (101) follows the motion of one object (301) as opposed to that of a second object (302), the camera captures and conveys the eye pupil motion (303). Using that conveyed eye-pupil-motion signal which contains information about pupil horizontal (y) and vertical (x) displacement over time, the system compares the captured eye pupil movement as a curve (306) which can be compared the objects' x and y displacements as they move around the circular path. The object 301 has an x displacement curve over time of 304 whereas object 302 has a displacement curve of 305. The eye pupil displacement curve is shown as 306. Clearly, based on correlation, the pupil is following object 301 rather than 302. In a similar fashion, the y displacement curve of object 301 is shown as curve 308, and that of object 302 is shown as 307. Here, again, based on the pupil motion curve 309, it is clear that indeed the pupil is following the motion of object 301. This process of correlating eye pupil motion with screen-object motion is known as “smooth pursuit.” Detecting and correlating eye pupil motion with screen object motion is one key element of the invention.

As shown in FIG. 7A, if two or more targets (701 and 702) have a relatively small displacement from one another (705), it may be hard to distinguish at which target the user is looking (703 and 704). In that case, if more than one target exceeds a certain level of correlation with the user's eye movement, the system will increase the displacement between these targets (FIG. 7B, 705) by slowly moving the targets away from each other on their path. This in turn will make it easier to distinguish which one is attended because the phase difference of their respective motion curves (FIG. 7B 703 and 704) will be larger. After activation, or if it becomes clear that the user was not looking at any of the targets, they will return to their original position on the path.

Another key element is providing fast feedback to the user confirming which screen object is being attended. As shown in FIGS. 4A, B and C, one embodiment makes use of changing displayed object size to convey object-attended confirmation, followed by a change in object position. Thus, for example, if the user attends object 401 as shown in FIG. 4A, the figure may grow in size (FIG. 4B, 402) and then move to the center, or outside the circumference, of the circular paths (FIG. 4B, 403). Once so centered, or removed from the circular circumference, the object can now be decomposed into three new objects, each containing only one of n data bits that were originally combined in object (401). Thus, for example, if object 401 had the characters A, B and C in it, after 401 moves to the center position, it is changed into a set of objects (FIG. 4C, 404) one of which contains A, one of which contains B and a third contains C (not shown). Thus, as a progression, the user needs, say, the letter B for the word “back” that he/she is constructing. The object 401 is shown to contain A, B and C. The user attends object 401 and it ultimately deconstructs into three new objects, one each of A, B and C. By selecting the new object containing only B, the user has selected B. If the outer circular path objects of FIG. 2 contain categorical groupings, such as alphabetic characters, and the inner circular path comprises objects containing groupings of those alphabetic characters, a user may adopt a quick two-step process to first select a category (letters) and then a letter (B).

It may be very useful for a user to vary the rotational speed of the objects moving around a circular path. FIGS. 5A, B and C show one embodiment of hands-free rotation speed control. As shown in FIG. 5A, the objects are following a clock-wise path 501 and the user attends object 502. Next, as in FIG. 5B, the user skips to object 503 which is not adjacent to object 502 from FIG. 5A. The system detects this motion discontinuity and determines whether the skip was to an object in the same rotation direction or opposite direction. Here, it is in the same direction, so as shown in FIG. 5C, the rotation speed will increase (504).

Similarly, as shown in FIGS. 6A, B and C, another embodiment is illustrated wherein the user skips from the first object (602) as selected in FIG. 6A while moving at a rotational speed of 601; to a second object (603) as shown in FIG. 6B. Here, the user has skipped in a direction opposite that of the rotational direction. The system detects a motion discontinuity and determines whether it was in the direction of rotation or in the opposite direction. Here, the second object is in a direction opposite that of rotation, so the system responds by slowing the rotation speed (604).

Note that the drawings and disclosure describes exemplary descriptions and should not be read as limiting the invention to those examples. For example, object size changes need not be confined to an increase in size. It could well entail a decrease. The object that moves off the circumference could now be positioned in the center, or above, or to the side of the circular circumference. The objects shown are rectangular but could as well be circular, ovoid, triangular, or any closed geometric figure. The data contained within an icon can be a control word or symbol, an alphanumeric element, an emoticon, or the like. Essentially, anything that a user may select using a keyboard, mouse, touch-screen, touch-pad, or voice control interface may also be selected and deployed using this hands-free interface.

What is claimed is:

1. A hands-free interface system comprising:
a graphic display subsystem;
a programmatic processing subsystem;
a user watching said display subsystem;
an electronic camera directed toward said user watching said graphic display subsystem;
one or more programs residing in said system;
said graphic display subsystem comprising:
an electronic display operative to display colored objects in animated motion;
an electronic display driver operative to convert display data into said colored objects in said animated motion;
said programmatic processing subsystem comprising:
a processor;
read/write dynamic memory;
non-volatile storage memory;
a data input/output subsystem;
said electronic camera operative to capture eye motion changes converting said eye motion changes into associated digital data, and conveying said associated digital data to said programmatic processing subsystem;
said one or more programs operative to instruct said programmatic processing subsystem to determine, based on said associated digital data, said display screen colored object to which said user's eye is directed;
said one or more programs operative to instruct said programmatic processing subsystem to change said display screen colored objects' appearances by conveying said display data to said graphic display driver;
said one or more programs operative to instruct said programmatic processing subsystem to store a data value associated with said display screen colored object to which said user's eye is directed and to use said value as data input; and
said one or more programs operative to instruct said programmatic processing subsystem to store a control value associated with said display screen colored object to which said user's eye is directed and to use said value as a control input.

2. A system as in claim 1 further comprising:
said display screen colored object is a geometrically shaped icon.

3. A system as in claim 1 further comprising:
said display screen colored objects move around said electronic display on one of two concentric geometric paths, an outer path with a larger circumference and an inner path with a smaller circumference.

4. A system as in claim 3 further comprising:
said display screen colored objects moving around said electronic display on said outer path travel in a first rotational direction;
said display screen colored objects moving around said electronic display on said inner path travel in a second rotational direction which is always opposite that of said first rotational direction.

5. A system as in claim 1 further comprising:
said display screen colored objects' changed appearances comprising:
changes in size;
changes in said display screen position from said outer path and said inner path to essentially to a position that is not on said outer path or said inner path.

6. A system as in claim 3 further comprising:
rotational speed of said display screen colored objects in said outer path are increased by said user's eye motion skipping to said objects further away in same direction; and
said rotation speed of said display screen colored objects in said outer path are decreased by said user's eye motion skipping to said objects further away in opposite direction.

7. A system as in claim 3 further comprising:
said rotational speed of said display screen colored objects in said inner path are increased by said user's eye motion skipping to said objects further away in said same direction; and
said rotation speed of said display screen colored objects in said inner path are decreased by said user's eye motion skipping to said objects further away in said opposite direction.

8. A system as in claim 1 further comprising:
said one or more programs operative to instruct said programmatic processing subsystem to store a control value associated with said display screen colored object to which said user's eye is directed, and to which user's eye attention is sustained for a longer period of time, and to use said value as a repetitive control input.

9. A method comprising:
looking by a user at a display screen object as it travels on a circular path;
detecting by an electronic camera said display screen object at which said user is attending;
changing, by a system, said display screen object's appearance as feedback to said user;
determining, by said system, a data value, if any, associated with said display screen object;
using, by said system, said data value as a data input;
determining, by said system, a control value, if any, associated with said display screen object; and
using, by said system, said control value as a control input.

10. A method as in claim 9 further comprising:
changing, by said system, said display screen object's appearance by increasing its size.

11. A method as in claim 9 further comprising:
changing, by said system, said display screen object's appearance by decreasing its size.

12. A method as in claim 9 further comprising:
changing, by said system, said display screen object's appearance by moving said screen object to a position not on said circular path.

13. A method as in claim 9 further comprising:
changing, by said system, relative position of two adjacent said display screen objects to increase phase difference between said display screen objects' motion curves.

14. A method as in claim 9 further comprising:
detecting by said electronic camera said display screen object at which said user is attending;
timing, by said system, the duration of said user's attention;
determining, by said system, a control value, if any associated with said display screen object;
determining, by said system, if said timing exceeds a predetermined time duration;
if timing is less than said predetermined time duration, then using, by said system, said control value as a control input;
if timing exceeds said predetermined time duration, then using, by said system, a repeating control value.

15. A method comprising:
detecting, by said system, said user's attention to a first said screen object;
detecting, by said system, said user's attention to a second said screen object; and
determining if said first and said second screen objects are adjacent to one another.

16. A method as in claim 14 further comprising:
if said first and said second screen objects are adjacent to one another, then making, by the system, no change in rotation speed of said objects traveling in a circular path containing said first and second objects.

17. A method as in claim 14 further comprising:
if said first and said second screen objects are not adjacent to one another, then determining, by said system, if said second object leads or lags said first object in the direction of rotation.

18. A method as in claim 16 further comprising:
if said second object leads said first object in the direction of rotation, then increasing, by said system, said rotation speed of said objects contained in said circular path.

19. A method as in claim 16 further comprising:
if said second object lags said first object in the direction of rotation, then decreasing, by said system, said rotation speed of said objects contained in said circular path.
